(19) United States
(12) Patent Application Publication
(10) Pub. No.: US 2014/0043269 A1
(43) Pub. Date: Feb. 13, 2014

(54) Operating Device in a Vehicle

(71) Applicants: Mathias Kuhn, Berlin (DE); Alexander Hahn, Braunschweig (DE); Simon Defoort, Braunschweig (DE); George Paravantes, Toronto (CA)

(72) Inventors: Mathias Kuhn, Berlin (DE); Alexander Hahn, Braunschweig (DE); Simon Defoort, Braunschweig (DE); George Paravantes, Toronto (CA)

(21) Appl. No.: 13/985,831

(22) PCT Filed: Feb. 10, 2012
(86) PCT No.: PCT/DE12/00124

§ 371 Date: Oct. 1, 2013

(30) Foreign Application Priority Data
Feb. 17, 2011 (DE) 10-2011-011-606.0

(51) Int. Cl. G06F 3/041

(52) U.S. Cl. CPC G06F 3/041
USPC 345/173

(57) ABSTRACT

An operating device in a vehicle includes a mobile operating device having a display area on which at least one display element to which multiple functions are assigned is displayable, a mounting support accommodating the mobile operating device, an input device for implementing an input assigned to a function associated with the display element, and a control unit for generating a control command based on an input. The mounting support can position the mobile operating device in at least two positions, and a position-detection device detects positions of the mobile operating device. The functions assigned to the display element are subdivided into at least two function groups, only control commands of the first function group are generatable if the mobile operating device is in a first position, and only control commands of the second function group are generatable if the mobile operating device is in the second position.

### FIELD OF INVENTION

The present invention relates to an operating device in a vehicle equipped with a mobile operating device, which includes a display area, on which at least one display element to which multiple functions are assigned is able to be displayed. In addition, the operating device includes a mounting support, which is able to accommodate the mobile operating device, and an input device for implementing an input assigned to a function associated with the display element. Moreover, the operating device includes a control unit for generating a control command as a function of an input into the input device.

### BACKGROUND INFORMATION

With the increase in electronic devices in the vehicle it became necessary to display larger quantities of information inside the vehicle. In addition to a multifunction display, modern vehicles, for example, are equipped with a multitude of driver-assistance systems, for which the information must be displayed inside the vehicle. In addition, vehicles frequently include a navigation system. Such a navigation system is able to display digital geographic road maps together with a route and possibly a whole slew of supplementary information. Finally, modern vehicles often come equipped with communication and multimedia applications, including a mobile telephone interface and devices for music and voice playback. These applications also require the display of information.

For example, freely programmable displays, which often also assume the display of traditional mechanical instruments, are employed to display the manifold information in a flexible manner. German Application No. DE 10 2006 032 118, for instance, describes an instrument cluster for a motor vehicle equipped with a display which can be used for the variable display of the speed of the motor vehicle, the engine speed of the motor of the motor vehicle, the temperature of the motor of the motor vehicle, the tank level and/or the time. In addition, information from a navigation system, a telephone, a music system, an infotainment system and/or climate-control system is displayable.

Apart from the instrument cluster, a display device is frequently situated above the center console of the vehicle, which can be employed to display additional information. This display device in particular is used as a multifunction display and for the display of a geographic map of a navigation system. Such a multifunction display is described in German Application No. DE 199 41 956, for example.

Very special requirements arise in connection with the display of information in a vehicle. The information in the vehicle, for one, is to be understood by the driver and, for another, by a passenger, as the case may be. It should be noted here that certain functions are intended solely for the passenger. The driver may not execute these functions because they would distract him during driving. Consequently, it has been proposed to use a so-called dual-view display, in which different display content is viewable as a function of the viewing angle. Such a dual-view display, for example, can show the display of the navigation system to the driver, and a video to the passenger.

### SUMMARY

Example embodiments of the present invention provide an operating device of the type mentioned in the introduction, which is able to execute functions both for the driver and for the passenger, but which does not adversely affect the safety while the vehicle is in operation.

A characteristic feature of the operating device is that the mounting support is developed so that the mobile operating device is able to be positioned in at least two positions. In addition, the operating device includes a position-detection device which is linked to the control unit and able to record the positions of the mobile operating device accommodated by the mounting support. The functions assigned to the at least one display element are subdivided into at least two function groups. The control unit is developed so that only control commands of the first function group are able to be generated if the position-detection device has detected that the mobile operating device is in a first position, and that only control commands of the second function group are able to be generated if the position-detection device has detected that the mobile operating device is in the second position.

In the first position in the vehicle, the mobile operating device is positioned for an operation by the driver, in particular. In the second position, it is positioned for an operation by the passenger, in particular. The first function group thus relates to functions that the driver of the vehicle is allowed to execute. The second function group pertains to functions that may be executed by the passenger of the vehicle. The functions of the first or the second function group differ from the respective other function group in at least one function. However, the second function group may encompass all of the functions of the first function group. In this case, the second function group includes functions that are not encompassed by the first function group. These functions of the second function group that are not contained in the first function group, for example, relate to the playback of a video movie or access to the Internet overall, or access to only certain pages on the Internet. Such functions may not be executed by the driver while engaged in driving. That is to say, they are blocked when the mobile operating device is in the first position, which is assigned to the driver of the vehicle.

As a result, it is ensured in the operating device that certain functions are enabled only if the mobile operating device is in the second position, i.e., the position assigned to the passenger. The operating device thus renders a contribution to safety while the vehicle is driven.

The at least one display element displayed on the display area of the mobile operating device may be shown in a first type of display if the position-detection device has detected that the mobile operating device is in the first position, and the display element may be shown in a second type of display if the position-detection device has detected that the mobile operating device is in the second position. Such a development makes it possible to adapt the display of the display element to the individual viewer. If the mobile operating device is in the position provided for the driver, the information relevant to the driver is able to be highlighted in the display type of the display element. On the other hand, if the mobile operating device is in the position provided for the passenger, the display type may be adapted to the needs of a passenger. In the first display type set up for the driver, the information in particular is shown such that the driver is able to understand it in an especially rapid and intuitive manner. For example, operating parameters of the vehicle or information of the navigation system relevant in the navigation context are shown in especially large size, so that the driver is able to see it quickly. Furthermore, display content that is of only marginal importance to the driver may be faded out or shown in smaller size. In the second display type, configured for the passenger, it may be taken into account that the passenger is able to keep his eyes on the display area for longer without having to glance away from time to time. Thus, it is possible to show more information within the display element, possibly also in smaller size.

The mounting support may include a bar and a receiving device. The receiving device is developed to accommodate the mobile operating device, especially such that the latter is able to be removed. For example, it is possible to place the mobile operating device inside the receiving device, or it may be plugged on top of the receiving device. The receiving device may be displaceable along the bar. Sections of the bar are assigned to the first and the second position of the mobile operating device in such a case.

The bar is situated on the instrument panel of the vehicle, in particular. For example, it extends from the center of the vehicle to the edge of the vehicle on the passenger side. It may furthermore be the case that the angle of the receiving device, and thus the alignment of the display area of the mobile operating device, varies as a function of the position of the receiving device. In the first position, the mobile operating device, which is situated in the receiving device, may be tilted in the direction of the seating position of the driver, and in the second position, the display area of the mobile operating device may be facing toward the seating position of the passenger. This makes it possible to shift the mobile operating device disposed in the receiving device in a very simple and fluent manner inside the vehicle.

The input device may include operating elements fixedly disposed in the vehicle, and/or operating elements of the mobile operating device. For example, the operating elements fixedly disposed inside the vehicle may be situated on the steering wheel of the vehicle or at the mounting device. These operating elements may be developed to operate vehicle functions. However, as an alternative or in addition, they may also be designed to operate functions assigned to display elements that are displayed on the display area of the mobile operating device. Furthermore, the surface of the display area of the mobile operating device may have a touch-sensitive design, so that the mobile operating device represents a so-called touchscreen. In such a case this touchscreen constitutes part of the input device as well. The vehicle functions and the functions of the mobile operating device are thereby able to be operated by a user in a multitude of ways, and the operation may be adapted to the situation within the vehicle. In particular, functions which the driver must access quite often are able to be executed by operating elements on the steering wheel of the vehicle. In contrast, functions that are frequently required by the passenger may be actuated by operating elements on the mounting support for the mobile operating device.

The operating device may include a first interface for the data exchange between the mobile operating device and a data bus of the vehicle. This interface may be a wire-bound or a wireless interface. In this way the mobile operating device is integrated into the communication structure of the vehicle.

Moreover, the operating device may include a second interface for the data exchange between the mobile operating device and the mounting support, and a third interface for the data exchange between the mounting support and a data bus of the vehicle. The mounting support thus is usable not only for the mechanical fixation of the mobile operating device, but also for the electronic linking of the mobile operating device to the data bus of the vehicle. The third interface may correspond to the previously mentioned first interface.

The operating device may include a processing device by which communication links to the Internet and/or mobile telephony networks are able to be established. Using the processing device, it is therefore possible in an advantageous manner to access not only devices of the vehicle by the operating device, but also external devices such as Internet servers and devices of a mobile telephony network.

Finally, the present invention pertains to a vehicle having an operating device as described herein.

Further features and aspects of example embodiments of the present invention are explained in greater detail below with reference to the appended Figures.

### BRIEF DESCRIPTION OF THE DRAWINGS

FIG. 1 schematically shows the general configuration of an example embodiment of the operating device according to the present invention.

FIG. 2 shows the set-up of the example embodiment of the operating device according to the present invention in a vehicle, in which the mobile operating device is disposed in a first position.

FIG. 3 shows the display on the display area of the mobile operating device in the first position.

FIG. 4 shows the set-up of the example embodiment of the operating device according to the present invention in a vehicle, in which the mobile operating device is disposed in a second position.

FIG. 5 shows the display on the display area of the mobile operating device in the second position.

### DETAILED DESCRIPTION

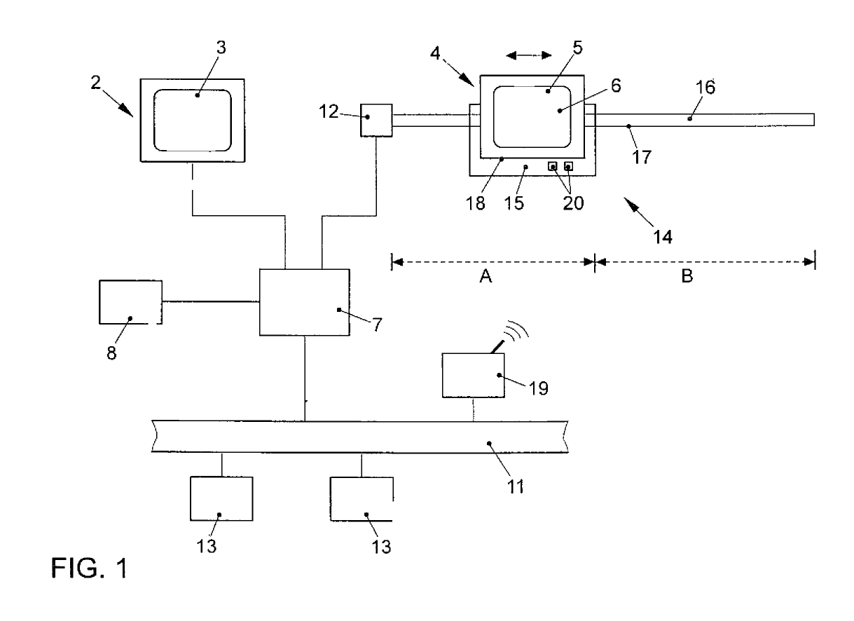

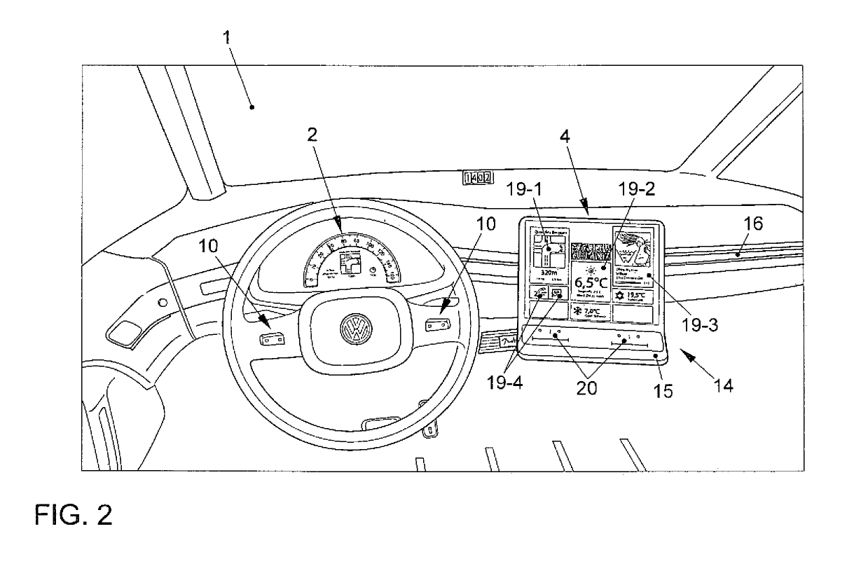

Hereinafter, the general configuration of the example embodiment of the operating device according to the present invention will be elucidated with reference to FIGS. 1 and 2.

In a manner known per se, an instrument cluster having a display device 2 is situated inside a vehicle 1, the display device including a first display area 3 in the direct field of vision of the driver of vehicle 1. A mounting support 14 for a mobile operating device 4, i.e., a device whose position is variable, is situated in a region that extends from the center console of vehicle 1 at the instrument panel to the outer edge of the seating position of the passenger. Mobile operating device 4 includes a second display area 5, which is provided with a touch-sensitive surface 6. Thus, a so-called touchscreen is provided by mobile operating device 4.

Mounting support 14 includes a receiving device 15, which is developed so that mobile operating device 4 is not only variable in its position, but also removable. Receiving device 15 therefore accommodates mobile operating device 4 in detachable manner. It may be plugged onto receiving device 15, so that it is mechanically retained by receiving device 15. In addition, receiving device 15 has plugs that engage with sockets of mobile operating device 4 when mobile operating device 4 is retained by receiving device 15. This not only creates a mechanical mounting support, but also an electronic interface 18 for a data exchange between receiving device 15 and mobile operating device 4.

In addition, receiving device 15 includes a plurality of operating elements 20, via which, in particular, functions for which information is shown on display area 5 of mobile operating device 4 are able to be operated.

Mounting support 14 furthermore has a bar 16, which extends essentially horizontally along the instrument panel of vehicle 1, from the center console to the outer edge at the seating position of the passenger. Receiving device 15 is mounted on bar 16 so as to be shiftable. This allows the driver or passenger of vehicle 1 to shift mobile operating device 4 in receiving device 15 back and forth along bar 16.

Moreover, a position-detection device 17 is provided at bar 16, with whose aid the position of receiving device 15 at bar 16 is able to be detected. For example, it is possible to detect the position of receiving device 15 with the aid of electrical contacts.

In addition, data which have been transmitted via interface 18 from mobile operating device 4 to receiving device 15 are transmitted to a control unit 7 via bar 16 and another interface 12. This interface 12 is also used to transmit the position of receiving device 15 along bar 16 detected by position-detection device 17 to control unit 7. If receiving device 15 is in a region A, control unit 7 assigns a first position to receiving device 15. This position is assigned to the driver of vehicle 1. Region A is selected such that the driver of vehicle 1 is able to read out display area 5 of mobile operating device 4 without any problems in this position. On the other hand, if receiving device 15 is situated in region B, control unit 7 assigns a second position to receiving device 15, which is set up for the passenger.

Control unit 7 furthermore is linked to display device 2 of the instrument cluster of vehicle 1, and to operating elements 8.

In addition, control unit 7 is linked via a data bus 11 of the vehicle to other vehicle devices 13 and to a processing unit 19, which is able to establish communication links to the Internet and to mobile telephony networks. Using control unit 7, graphics data are generated for the display on display area 5 of mobile operating device 4. These graphics data are transmitted to mobile operating device 4 via interfaces 12 and 18.

Display elements 19-n, in particular, are shown on display area 5. For one, these display elements 19-n may be assigned to different vehicle devices 13, e.g., navigation devices such as the navigation system, driver-assistance devices, multimedia devices and communication devices. For example, display elements 19-n could be so-called function widgets, which display messages from an email program of a telecommunication device or a weather service. For another, display elements 19-n may be assigned to applications that display operating parameters of the vehicle.

Functions assigned to display element 19-n are able to be executed via the various operating elements 8, 10 and 20. When operating elements 8, 10 and 20 are actuated, control unit 7 generates an associated control command which leads to the execution of the desired function.

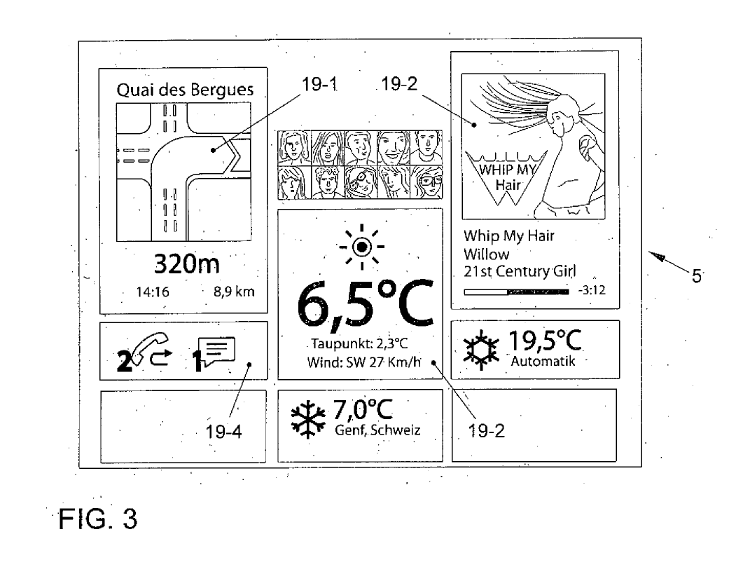

FIGS. 2 and 3 exemplarily show the display on display area 5 when position-detection device 17 has detected that receiving device 15 is situated in the first position, i.e., in region A. A display element 19-1 of the navigation system of vehicle 1, a display element 19-2 which displays the current temperature, the dew point and the wind speed, and a display element 19-3 of a music playback device of vehicle 1 are shown. Moreover, a display element 19-4 is shown, which is assigned to processing device 19 for communication links to the Internet and mobile telephony networks. In the example shown in FIGS. 2 and 3, display element 19-4 visualizes that two missed telephone calls were received and a new email has arrived.

At least one display element 19-n displayed on display area 5 of mobile operating device 4 is assigned to multiple functions. As an example, this will be explained with the aid of display element 19-4 of processing device 19. By actuating operating elements 8, 10 and 20, the user in vehicle 1 is able to make telephone calls, call up emails from a vehicle-external server, or have websites from the Internet displayed on display area 5. For example, videos from a video server on the Internet are able to be displayed to the user on display area 5. These different types of functions are assigned to display element 19-4, which is part of processing device 19. The user is able to generate control commands via operating elements 8, 10 and 20. This operator action is visualized by display element 19-4.

The functions that are assigned to display element 19-4 are now subdivided into two function groups within control unit 7 which is generating the corresponding control commands. The first function group includes of all of the functions that may be executed both by the driver and the passenger. The second function group includes the functions that may be executed only by the passenger, but not the driver. For example, calling up a video service on the Internet is part of the second function group. Control unit 7 now is configured such that only control commands of the first function group can be generated if position-detection device 17 has detected that mobile operating device 4, i.e., receiving device 15 for mobile operating device 4, is in the first position. If position-detection device 17 has detected that mobile operating device 4, i.e., its receiving device 15, is in the second position, only control commands of the second function group are able to be generated.

In the example described here this means that functions such as calling up video services on the Internet are unable to be executed in the first position of the mobile operating device, which is provided for the driver of vehicle 1. However, if mobile operating device 4 is in the second position for the passenger of vehicle 1, all functions that are assigned to display element 19-4 are able to be executed.

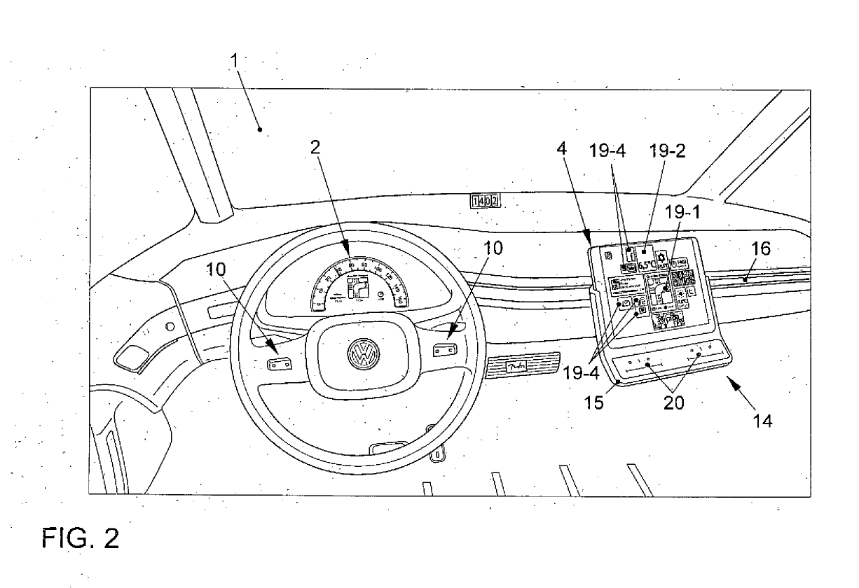

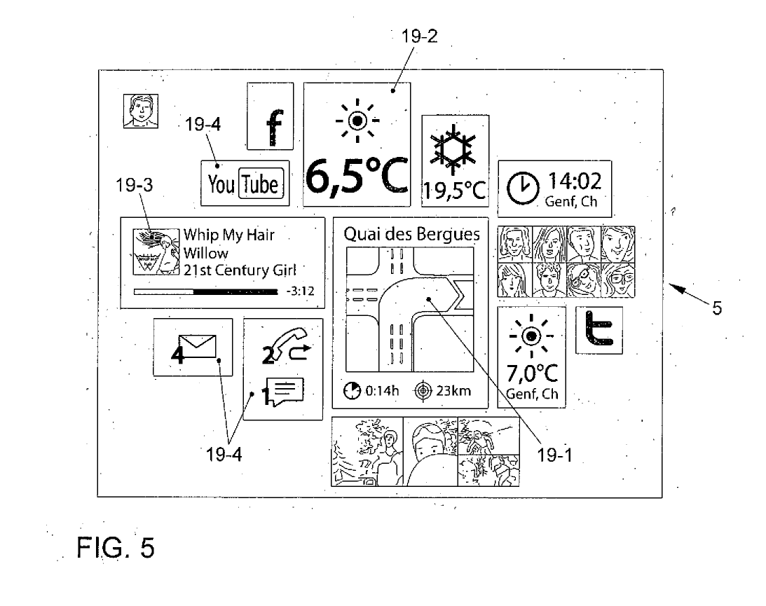

FIGS. 4 and 5 show mobile operating device 4 in the second position, and the corresponding display on display area 5 of mobile operating device 4. In this case, display element 19-4 is subdivided into a plurality of elements, one display element 19-4, for example, being assigned to a video service on the Internet. If the user actuates this operating element 19-4, for instance by touching touch-sensitive surface 6 of mobile operating device 4, this video service is called up, and the passenger will be able to watch videos of this video server. This function is blocked when mobile operating device 4 is in the first position.

In addition, different display elements 19-n are shown in a first type of display if mobile operating device 4 is in the first position, and in another, second type of display if mobile operating device 4 is in the second position.

### LIST OF REFERENCE NUMERALS

1 Vehicle

2. Display device

3. First display area

4 Mobile operating device

5 Second display area

6 Touch-sensitive surface

7 Control device

8 Operating elements

9 Steering wheel

10 Operating elements

11 Data bus

12 First interface

13 Vehicle devices

14 Mounting support

15 Receiving device

16 Bar

17 Position-detection device

18 Second Interface

19 Processing device

19-n Display elements

20 Operating elements

1.-10. (canceled)

11. An operating device in a vehicle, comprising:
a mobile operating device including a display area on which at least one display element to which multiple functions are assigned is displayed;
a mounting support accommodating the mobile operating device;
an input device configured to implement an input which is assigned to a function associated with the display element; and
a control unit configured to generate a control command as a function of the input into the input device;
wherein the mounting support is configured such that the mobile operating device is positionable in at least two positions;
wherein the operating device includes a position-detection device linked to the control unit, by which the positions of the mobile operating device accommodated by the mounting support are recorded;
wherein the functions assigned to the display element are subdivided into at least two function groups; and
wherein the control unit is configured such that only control commands of a first function group are able to be generated if the position-detection device detects that the mobile operating device is in a first position, and only control commands of a second function group are able to be generated if the position-detection device detects that the mobile operating device is in a second position.

12. The operating device according to claim 11, wherein the mobile operating device is placed in the first position in the vehicle for an operation by a driver, and in the second position for an operation by a passenger.

13. The operating device according to claim 11, wherein the at least one display element displayed on the display area of the mobile operating device is shown in a first display state if the position-detection device detects that the mobile operating device is in the first position, and the display element is shown in a second display state if the position-detection device detects that the mobile operating device is in the second position.

14. The operating device according to claim 11, wherein the mounting support includes a bar and a receiving device for reversible accommodation of the mobile operating device, the receiving device being movable along the bar, and sections of the bar being assigned to the first and the second positions of the mobile operating device.

15. The operating device according to claim 11, wherein the input device includes operating elements which are fixedly situated in the vehicle, and/or operating elements of the mobile operating device.

16. The operating device according to claim 14, wherein the input device includes operating elements which are fixedly situated in the vehicle, and/or operating elements of the mobile operating device.

17. The operating device according to claim 15, wherein the operating elements fixedly situated in the vehicle are situated at the mounting support, and are configured to operate vehicle functions and/or to operate functions assigned to display elements that are displayed on the display area of the mobile operating device.

18. The operating device according to claim 11, further comprising:
a first interface for data exchange between the mobile operating device and a data bus of the vehicle.

19. The operating device according to claim 18, further comprising:
a second interface for data exchange between the mobile operating device and the mounting support, and a third interface for data exchange between the mounting support and a data bus of the vehicle.

20. The operating device according to claim 11, further comprising:
a processing device with whose aid communication links to Internet and/or to mobile telephony networks are able to be established.

21. A vehicle having an operating device, the operating device comprising:
a mobile operating device including a display area on which at least one display element to which multiple functions are assigned is displayed;
a mounting support accommodating the mobile operating device;
an input device configured to implement an input which is assigned to a function associated with the display element; and
a control unit configured to generate a control command as a function of the input into the input device;
wherein the mounting support is configured such that the mobile operating device is positionable in at least two positions;
wherein the operating device includes a position-detection device linked to the control unit, by which the positions of the mobile operating device accommodated by the mounting support are recorded;
wherein the functions assigned to the display element are subdivided into at least two function groups; and
wherein the control unit is configured such that only control commands of a first function group are able to be generated if the position-detection device detects that the mobile operating device is in a first position, and only control commands of a second function group are able to be generated if the position-detection device detects that the mobile operating device is in a second position.

22. The vehicle according to claim 21, wherein the mobile operating device is placed in the first position in the vehicle for an operation by a driver, and in the second position for an operation by a passenger.

23. The vehicle according to claim 21, wherein the at least one display element displayed on the display area of the mobile operating device is shown in a first display state if the position-detection device detects that the mobile operating device is in the first position, and the display element is shown in a second display state if the position-detection device detects that the mobile operating device is in the second position.

24. The vehicle according to claim 21, wherein the mounting support includes a bar and a receiving device for reversible accommodation of the mobile operating device, the receiving device being movable along the bar, and sections of the bar being assigned to the first and the second positions of the mobile operating device.

25. The vehicle according to claim 21, wherein the input device includes operating elements which are fixedly situated in the vehicle, and/or operating elements of the mobile operating device.

26. The vehicle according to claim 24, wherein the input device includes operating elements which are fixedly situated in the vehicle, and/or operating elements of the mobile operating device.

27. The vehicle according to claim 25, wherein the operating elements fixedly situated in the vehicle are situated at the mounting support, and are configured to operate vehicle functions and/or to operate functions assigned to display elements that are displayed on the display area of the mobile operating device.

28. The vehicle according to claim 21, wherein the operating device further comprises:
a first interface for data exchange between the mobile operating device and a data bus of the vehicle.

29. The vehicle according to claim 28, wherein the operating device further comprises:
a second interface for data exchange between the mobile operating device and the mounting support, and a third interface for data exchange between the mounting support and a data bus of the vehicle.

30. The vehicle according to claim 21, wherein the operating device further comprises:
a processing device with whose aid communication links to Internet and/or to mobile telephony networks are able to be established.
